(19) United States
(12) Patent Application Publication
(10) Pub. No.: US 2010/0238188 A1
(43) Pub. Date: Sep. 23, 2010

(54) Efficient Display of Virtual Desktops on Multiple Independent Display Devices

(76) Inventor: Sean Miceli, San Jose, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/408,522

(22) Filed: Mar. 20, 2009

(51) Int. Cl. G09G 5/00; G06T 1/20; G06F 3/048; G09G 5/36

(52) U.S. Cl. 345/582; 345/506; 715/761; 345/545

(57) ABSTRACT

Methods having corresponding apparatus and computer-readable media embodying instructions executable by a computer to perform the methods comprise placing content of a window of a virtual desktop generated by a graphical user interface into an OpenGL scene; rendering the OpenGL scene to a buffer of a first graphical processing unit (GPU); providing a first portion of the contents of the buffer of the first GPU to a first display device; copying a second portion of the contents of the buffer of the first GPU to a buffer of a second GPU; and providing contents of the buffer of the second GPU to a second display device; wherein the first and second display devices together create a single composite display of the virtual desktop.

### BACKGROUND

The present disclosure relates generally to computer display techniques. More particularly, the present disclosure relates to display of virtual desktops on multiple independent display devices.

It is now commonplace to use multiple display devices in order to generate a large computer display. For example, a virtual desktop can span multiple monitors, thereby creating a larger display than a single monitor could provide. Another increasingly popular technique is to employ multiple projectors to generate a large composite projection. The projector case presents two problems not presented by the multiple monitor case. First, misalignment of the projectors with the projection surface produces keystoning and other distortions. Second, misalignment of the projectors with each other can create overlaps between the projections that appear brighter than the non-overlapped areas.

Manual projector alignment is time-consuming and tedious. Consequently, computer techniques have been developed to correct these misalignments by manipulating the image data before projection, thereby removing the need for manual alignment of the projectors. According to one class of these techniques, a warping matrix is applied to the image data, where the warping matrix compensates for the misalignments. However, these techniques have been implemented at a high level within the computer software environment, causing them to execute at an undesirably low speed.

### SUMMARY

In general, in one aspect, an embodiment features computer-readable media embodying instructions executable by a computer to perform a method comprising: placing content of a window of a virtual desktop generated by a graphical user interface into an OpenGL scene; rendering the OpenGL scene to a buffer of a first graphical processing unit (GPU); providing a first portion of the contents of the buffer of the first GPU to a first display device; copying a second portion of the contents of the buffer of the first GPU to a buffer of a second GPU; and providing contents of the buffer of the second GPU to a second display device; wherein the first and second display devices together create a single composite display of the virtual desktop.

Embodiments of the computer-readable media can include one or more of the following features. In some embodiments, placing content of the window of the virtual desktop generated by the graphical user interface into the OpenGL scene comprises placing the window in an output mode, wherein the window provides updates when placed in the output mode; and copying the updates of the window to the OpenGL scene. In some embodiments, copying updates of the window to the OpenGL scene comprises converting the updates of the window to OpenGL textures; and rendering the OpenGL textures upon a shape in the OpenGL scene. In some embodiments, rendering the OpenGL scene to a buffer of the first GPU comprises rendering the OpenGL scene to an OpenGL frame buffer object. In some embodiments, copying a second portion of the contents of the buffer of the first GPU to the buffer of the second GPU comprises placing the second portion in a pixel buffer object; and performing a direct memory access transfer of the pixel buffer object. Some embodiments comprise selecting a size of the virtual desktop according to a desired size of the composite display. In some embodiments, the first display device comprises at least one first projector, the second display device comprises at least one second projector; providing the first portion of the contents of the buffer of the first GPU to the first projector comprises warping the first portion; and providing the contents of the buffer of the second GPU to the second projector comprises warping the contents of the buffer of the second GPU. Some embodiments comprise providing a third portion of the contents of the buffer of the first GPU to a third display device; and providing a portion of the contents of the buffer of the second GPU to a fourth display device; wherein the first, second, third, and fourth display devices together create the single composite display of the virtual desktop.

In general, in one aspect, an embodiment features an apparatus comprising: a window module adapted to place content of a window of a virtual desktop generated by a graphical user interface into an OpenGL scene; a render module adapted to render the OpenGL scene to a buffer of a first graphical processing unit (GPU); a first display module adapted to provide a first portion of the contents of the buffer of the first GPU to a first display device; a copy module adapted to copy a second portion of the contents of the buffer of the first GPU to a buffer of a second GPU; and a second display module adapted to provide contents of the buffer of the second GPU to a second display device; wherein the first and second display devices together create a single composite display of the virtual desktop.

Embodiments of the apparatus can include one or more of the following features. In some embodiments, the window module comprises: a mode module adapted to place the window in an output mode, wherein the window provides updates when placed in the output mode; and an update module adapted to place the updates of the window in the OpenGL scene. In some embodiments, the render module is further adapted to convert the updates of the window to OpenGL textures; and wherein the render module is further adapted to render the OpenGL textures upon a shape in the OpenGL scene. In some embodiments, the render module is further adapted to render the OpenGL scene to an OpenGL frame buffer object in the buffer of the first GPU. In some embodiments, the copy module is further adapted to place the second portion in a pixel buffer object; and the copy module is further adapted to perform a direct memory access transfer of the pixel buffer object. Some embodiments comprise a size module adapted to select a size of the virtual desktop according to a desired size of the composite display. In some embodiments, the first display device comprises at least one first projector; the second display device comprises at least one second projector; the first GPU is further adapted to warp the first portion; and the second GPU is further adapted to warp the contents of the buffer of the second GPU. In some embodiments, the first display module is further adapted to provide a third portion of the contents of the buffer of the first GPU to a third display device; and the second display module is further adapted to provide a portion of the contents of the buffer of the second GPU to a fourth display device; wherein the first, second, third, and fourth display devices together create the single composite display of the virtual desktop.

In general, in one aspect, an embodiment features a method comprising: placing content of a window of a virtual desktop generated by a graphical user interface into an OpenGL scene; rendering the OpenGL scene to a buffer of a first graphical processing unit (GPU); providing a first portion of the contents of the buffer of the first GPU to a first display device; copying a second portion of the contents of the buffer of the first GPU to a buffer of a second GPU; and providing contents of the buffer of the second GPU to a second display device; wherein the first and second display devices together create a single composite display of the virtual desktop.

In some embodiments, placing content of the window of the virtual desktop generated by the graphical user interface into the OpenGL scene comprises: placing the window in an output mode, wherein the window provides updates when placed in the output mode; and copying the updates of the window to the OpenGL scene. In some embodiments, copying updates of the window to the OpenGL scene comprises: converting the updates of the window to OpenGL textures; and rendering the OpenGL textures upon a shape in the OpenGL scene. In some embodiments, rendering the OpenGL scene to a buffer of the first GPU comprises: rendering the OpenGL scene to an OpenGL frame buffer object. In some embodiments, copying a second portion of the contents of the buffer of the first GPU to the buffer of the second GPU comprises: placing the second portion in a pixel buffer object; and performing a direct memory access transfer of the pixel buffer object. Some embodiments comprise selecting a size of the virtual desktop according to a desired size of the composite display. In some embodiments, the first display device comprises at least one first projector; the second display device comprises at least one second projector; providing the first portion of the contents of the buffer of the first GPU to the first projector comprises warping the first portion; and providing the contents of the buffer of the second GPU to the second projector comprises warping the contents of the buffer of the second GPU. Some embodiments comprise providing a third portion of the contents of the buffer of the first GPU to a third display device; and providing a portion of the contents of the buffer of the second GPU to a fourth display device; wherein the first, second, third, and fourth display devices together create the single composite display of the virtual desktop.

The details of one or more implementations are set forth in the accompanying drawings and the description below. Other features will be apparent from the description and drawings, and from the claims.

### DESCRIPTION OF DRAWINGS

FIG. 1 shows an overview of a computer projection system according to some embodiments.

FIG. 2 shows a functional block diagram of the computer projection system of FIG. 1 according to some embodiments.

FIG. 3 shows a process for the computer projection system of FIGS. 1 and 2 according to some embodiments.

FIG. 4 shows an overview of the computer projection system of FIG. 1 with four projectors according to some embodiments.

The leading digit(s) of each reference numeral used in this specification indicates the number of the drawing in which the reference numeral first appears.

### DETAILED DESCRIPTION

Embodiments of the present invention provide efficient display of virtual desktops on multiple independent display devices. According to embodiments of the present invention, computer applications can be implemented within the graphical processing units (GPU) of multiple video cards in the computer, thereby dramatically increasing the speed at which the applications execute. According to one embodiment, the output of at least one window of a virtual desktop generated by an graphical user interface is placed in an OpenGL scene. The OpenGL scene is then rendered to a buffer of a first GPU. A first portion of the contents of the buffer of the first GPU is provided to at least one first display device, for example such as one or more projectors. A second portion of the contents of the buffer of the first GPU is copied to a buffer of a second GPU. The contents of the buffer of the second GPU are provided to at least one second display device. Together the display devices create a single composite display of the virtual desktop.

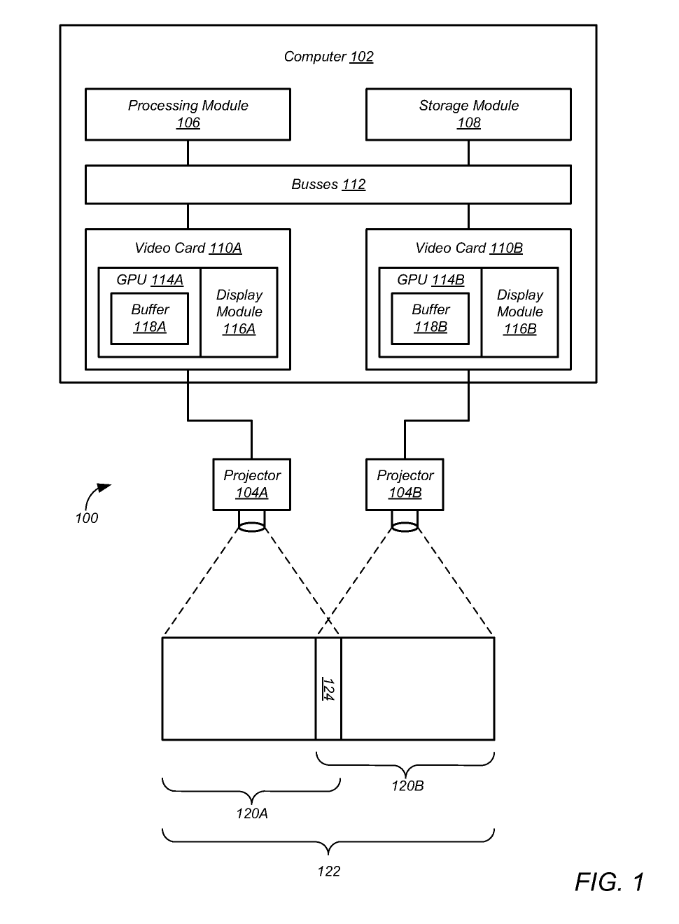

FIG. 1 shows an overview of a computer projection system 100 according to some embodiments. Although in the described embodiments, the elements of computer projection system 100 are presented in one arrangement, other embodiments may feature other arrangements, as will be apparent to one skilled in the relevant arts based on the disclosure and teachings provided herein. For example, the elements of computer projection system 100 can be implemented in hardware, software, or combinations thereof. In addition, the display devices are not limited to projectors, but can include other display devices such as monitors and the like.

Referring to FIG. 1, computer projection system 100 includes a computer 102 and projectors 104A and 104B. Computer 102 can be implemented as a standard general-purpose computer, a special-purpose computer, or the like. Projectors 104 can be implemented as commercially-available units.

Computer 102 includes a processing module 106, a storage module 108, and two video cards 110A and 110B. These elements communicate over one or more computer busses 112. Video card 110A includes a Graphics Processing Unit (GPU) 114A, a display module 116A, and a buffer 118A. Video card 110B includes a GPU 114B, a display module 116B, and a buffer 118B. Video cards 110 can be implemented as commercially-available units.

As used herein, the term “module” refers to hardware, software, or any combination thereof. The modules described herein can be implemented on any standard general-purpose computer, or can be implemented as specialized devices.

In operation, processing module 106 provides data and/or commands, which can be stored on storage module 108, to video cards 110 over busses 112. In response to the data and/or commands, GPUs 114 generate images in buffers 118, which are provided by display modules 116 to projectors 104. Projectors 104A and 104B project respective projections 120A and 120B upon a display surface. Together projections 120A and 120B form a single composite display 122. For example, display 122 can represent a virtual desktop generated by computer 102, as described below. Note that projections 120 overlap in an overlap region 124.

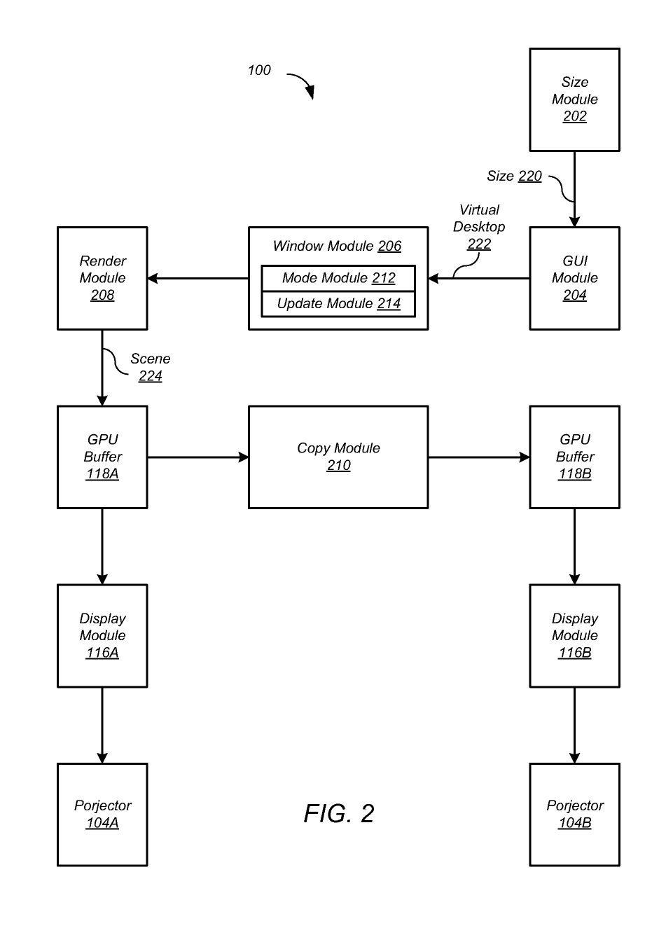

FIG. 2 shows a functional block diagram of computer projection system 100 of FIG. 1 according to some embodiments. Referring to FIG. 2, computer projection system 100 includes a size module 202, a graphical user interface (GUI) module 204, a window module 206, a render module 208, and a copy module 210. Window module 206 includes a mode module 212 and an update module 214. Also shown in FIG. 2 are video cards 110, including GPUs 114, display modules 116, and buffers 118.

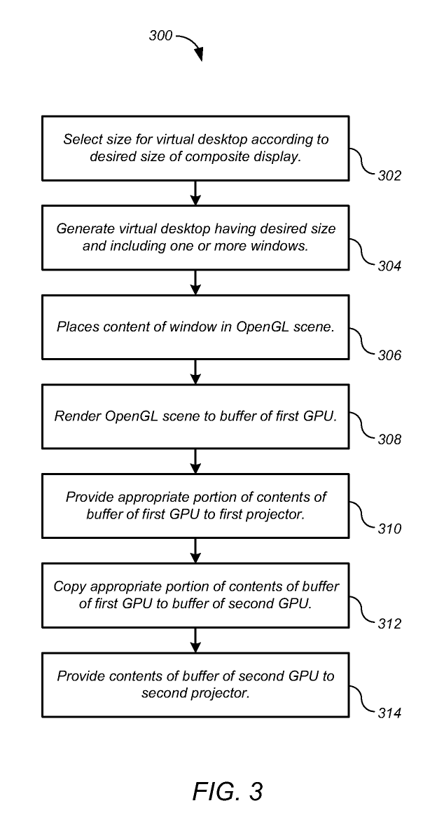

FIG. 3 shows a process 300 for computer projection system 100 of FIGS. 1 and 2 according to some embodiments. Although in the described embodiments, the elements of process 300 are presented in one arrangement, other embodiments may feature other arrangements, as will be apparent to one skilled in the relevant arts based on the disclosure and teachings provided herein. For example, in various embodiments, some or all of the steps of process 300 can be executed in a different order, concurrently, and the like.

Referring to FIG. 3, size module 202 selects a size 220 for a virtual desktop according to a desired size of composite display 122 (step 302). In general, size 220 is specified by resolution, and is selected to be slightly larger than the desired size of composite display 122, for example to allow for warping, masking, and similar operations. In response, GUI module 204 generates a virtual desktop 222 having the desired size 220 and including one or more windows (step 304). GUI module 204 can be implemented as X Windows or the like.

Rather than simply obtain virtual desktop 222 as a whole, embodiments of the present invention obtain each window within virtual desktop 222 individually, then combine the windows to reproduce virtual desktop 222. For clarity of description, the processing of one such window is described. Other windows are handled in a similar fashion. The desktop background can be obtained in a similar manner, or can be reproduced using graphics libraries such as OpenGL and the like.

Referring again to FIGS. 2 and 3, window module 206 places the content of the window in an OpenGL scene 224 (step 306). In particular, mode module 212 places the window in an output mode. The window provides updates to window module 206 when placed in output mode. For example, X Windows provides a composite window mode, which causes a window to provide updates to an application in the form of pixmaps. Update module 214 places the updates of the window in the OpenGL scene 224.

Render module 208 renders OpenGL scene 224 to buffer 118A of GPU 114A (step 308). For example, render module 208 converts the updates of the window to OpenGL textures, renders the OpenGL textures upon a shape, such as a rectangle, in OpenGL scene 224, and renders OpenGL scene 224 to an OpenGL frame buffer object in buffer 118A of GPU 114A.

Other windows of virtual desktop 222 are treated in a similar fashion, thereby reproducing virtual desktop 222 in buffer 118A of GPU 114A. At this point the task is to provide the appropriate portions of the reproduced virtual desktop 222 to each projector 104. As the required data is already present in the buffer 218 of the video card 110A connected to projector 104A, display module 216A provides the appropriate portion of the contents of buffer 218A to projector 104A (step 310).

To provide the remainder of reproduced virtual desktop 222 to projector 104B, the appropriate portion of the contents of buffer 218A must first be provided to the video card 110B connected to that projector 104B. To achieve this transfer, copy module 210 copies the appropriate portion of the contents of buffer 118A of GPU 114A to buffer 118B of GPU 114B (step 312). Copy module 210 preferably places this portion in a pixel buffer object, which allows the transfer to be made using direct memory access (DMA) if DMA is available. Once the transfer of the data to buffer 118B of GPU 114B is complete, display module 216B provides the contents of buffer 218B to projector 104B (step 314).

While warping is not required for display devices such as monitors, warping is usually needed for projectors. Therefore the data is preferably warped before the data is provided to projectors 104. In particular, warping can be applied to reproduced virtual desktop 222 by GPUs 114. The warping can be implemented by applying a separate warping matrix for each projector 104. For example, the warping can be implemented by OpenGL during fragment shading.

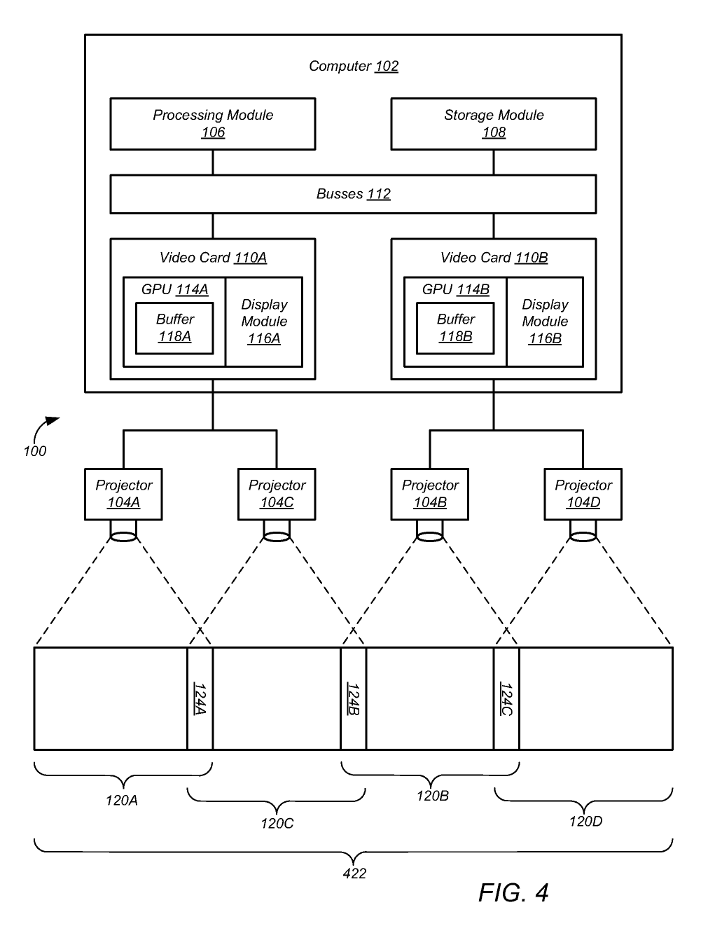

Many current video cards are capable of driving multiple display devices. A common implementation is to allow each video card to drive two display devices. FIG. 4 shows an overview of computer projection system 100 of FIG. 1 with four projectors 104 according to some embodiments. Referring to FIG. 4, video card 110A drives two projectors 104A and 104C, while video card 110B drives two projectors 104B and 104D.

In operation, processing module 106 provides data and/or commands, which can be stored on storage module 108, to video cards 110 over busses 112. In response to the data and/or commands, GPUs 114 generate images in buffers 118, which are provided by display modules 116 to projectors 104. Projectors 104A-104D project respective projections 120A-120D upon the display surface. Together projections 120A-120D form a single composite display 422. For example, display 422 can represent a virtual desktop generated by computer 102, as described below. Note that projections 120 overlap in overlap regions 124A-124C.

In the four-projector system of FIG. 4, virtual desktop 222 is sized according to the size of display 422, and is reproduced in the buffer 118 of the video card 110A connected to projector 104A, for example as described above. Display module 116A provides appropriate portions of the contents of buffer 118A to projectors 104A and 104C.

To provide the remainder of reproduced virtual desktop 222 to projectors 104B and 104D, the appropriate portion of the contents of buffer 218A are copied to buffer 118B of GPU 114B, for example as described above. Once the transfer of the data to buffer 118B of GPU 114B is complete, display module 216B provides appropriate portions of the contents of buffer 218B to projectors 104B and 104D.

Warping can be applied to reproduced virtual desktop 222 by GPUs 114. The warping can be implemented by applying a separate warping matrix for each projector 104. For example, the warping can be implemented by OpenGL during fragment shading.

As described above, some implementations employ X Windows. In these implementations, in order to have the X Windows server render the desktop to the size of the projected display 122, the desktop is placed in virtual desktop mode. This approach allows window processing to proceed as usual. For example, window management, overlapping windows, and icons are all handled with regular X Windows methods.

However, in some X Windows implementations, the X Windows server renders the mouse pointer as a hardware cursor. Fortunately, X Windows provides a facility to turn off the hardware cursor, and an extension to get the shape of the cursor. This allows a window manager to display an appropriate mouse cursor rather than a generic one.

In addition, the mouse pointer is locked to the main display. As the mouse causes the virtual display to be moved, the main display window is updated with the portion of the virtual display containing the mouse pointer. This is not what is needed. What is needed is to display the portion of the desktop that fits within the larger view of the projected display. This can be accomplished by displaying the correct view that fits in with the large projected view. As a result, the underlying window structures no longer have a one-to-one mapping with the display and the mouse pointer. A mapping is maintained to map mouse interactions to the correct part of the underlying display.

Embodiments of the present invention are not limited to the use of multiple projectors to create a large composite display. Some embodiments are directed to creating “super-bright” displays by using multiple projectors to illuminate the same part of a display surface. For example, the four-projector system of FIG. 4 can be modified to include four additional projectors illuminating the same display surface, thereby increasing the brightness of the composite display without changing its size.

Various embodiments can be implemented in digital electronic circuitry, or in computer hardware, firmware, software, or in combinations of them. Apparatus can be implemented in a computer program product tangibly embodied in a machine-readable storage device for execution by a programmable processor; and method steps can be performed by a programmable processor executing a program of instructions to perform functions by operating on input data and generating output. Embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations have been described. Nevertheless, it will be understood that various modifications may be made without departing from the spirit and scope of this disclosure. Accordingly, other implementations are within the scope of the following claims.

What is claimed is:

1. Computer-readable media embodying instructions executable by a computer to perform a method comprising:
placing content of a window of a virtual desktop generated by a graphical user interface into an OpenGL scene;
rendering the OpenGL scene to a buffer of a first graphical processing unit (GPU);
providing a first portion of the contents of the buffer of the first GPU to a first display device;
copying a second portion of the contents of the buffer of the first GPU to a buffer of a second GPU; and
providing contents of the buffer of the second GPU to a second display device;
wherein the first and second display devices together create a single composite display of the virtual desktop.

2. The computer-readable media of claim 1, wherein placing content of the window of the virtual desktop generated by the graphical user interface into the OpenGL scene comprises:
placing the window in an output mode, wherein the window provides updates when placed in the output mode; and
copying the updates of the window to the OpenGL scene.

3. The computer-readable media of claim 2, wherein copying updates of the window to the OpenGL scene comprises:
converting the updates of the window to OpenGL textures; and
rendering the OpenGL textures upon a shape in the OpenGL scene.

4. The computer-readable media of claim 1, wherein rendering the OpenGL scene to a buffer of the first GPU comprises:
rendering the OpenGL scene to an OpenGL frame buffer object.

5. The computer-readable media of claim 1, wherein copying a second portion of the contents of the buffer of the first GPU to the buffer of the second GPU comprises:
placing the second portion in a pixel buffer object; and
performing a direct memory access transfer of the pixel buffer object.

6. The computer-readable media of claim 1, further comprising:
selecting a size of the virtual desktop according to a desired size of the composite display.

7. The computer-readable media of claim 1:
wherein the first display device comprises at least one first projector;
wherein the second display device comprises at least one second projector;
wherein providing the first portion of the contents of the buffer of the first GPU to the first projector comprises warping the first portion; and
wherein providing the contents of the buffer of the second GPU to the second projector comprises warping the contents of the buffer of the second GPU.

8. The computer-readable media of claim 1, further comprising:
providing a third portion of the contents of the buffer of the first GPU to a third display device; and
providing a portion of the contents of the buffer of the second GPU to a fourth display device;
wherein the first, second, third, and fourth display devices together create the single composite display of the virtual desktop.

9. An apparatus comprising:
a window module adapted to place content of a window of a virtual desktop generated by a graphical user interface into an OpenGL scene;
a render module adapted to render the OpenGL scene to a buffer of a first graphical processing unit (GPU);
a first display module adapted to provide a first portion of the contents of the buffer of the first GPU to a first display device;
a copy module adapted to copy a second portion of the contents of the buffer of the first GPU to a buffer of a second GPU; and
a second display module adapted to provide contents of the buffer of the second GPU to a second display device;
wherein the first and second display devices together create a single composite display of the virtual desktop.

10. The apparatus of claim 9, wherein the window module comprises:
a mode module adapted to place the window in an output mode, wherein the window provides updates when placed in the output mode; and
an update module adapted to place the updates of the window in the OpenGL scene.

11. The apparatus of claim 10:
wherein the render module is further adapted to convert the updates of the window to OpenGL textures; and
wherein the render module is further adapted to render the OpenGL textures upon a shape in the OpenGL scene.

12. The apparatus of claim 9:
wherein the render module is further adapted to render the OpenGL scene to an OpenGL frame buffer object in the buffer of the first GPU.

13. The apparatus of claim 9:
wherein the copy module is further adapted to place the second portion in a pixel buffer object; and
wherein the copy module is further adapted to perform a direct memory access transfer of the pixel buffer object.

14. The apparatus of claim 9, further comprising:
a size module adapted to select a size of the virtual desktop according to a desired size of the composite display.

15. The apparatus of claim 9:
wherein the first display device comprises at least one first projector;
wherein the second display device comprises at least one second projector;
wherein the first GPU is further adapted to warp the first portion; and
wherein the second GPU is further adapted to warp the contents of the buffer of the second GPU.

16. The apparatus of claim 9:
wherein the first display module is further adapted to provide a third portion of the contents of the buffer of the first GPU to a third display device; and
wherein the second display module is further adapted to provide a portion of the contents of the buffer of the second GPU to a fourth display device;
wherein the first, second, third, and fourth display devices together create the single composite display of the virtual desktop.

17. A method comprising:
placing content of a window of a virtual desktop generated by a graphical user interface into an OpenGL scene;
rendering the OpenGL scene to a buffer of a first graphical processing unit (GPU);
providing a first portion of the contents of the buffer of the first GPU to a first display device;
copying a second portion of the contents of the buffer of the first GPU to a buffer of a second GPU; and
providing contents of the buffer of the second GPU to a second display device;
wherein the first and second display devices together create a single composite display of the virtual desktop.

18. The method of claim 17, wherein placing content of the window of the virtual desktop generated by the graphical user interface into the OpenGL scene comprises:
placing the window in an output mode, wherein the window provides updates when placed in the output mode; and
copying the updates of the window to the OpenGL scene.

19. The method of claim 18, wherein copying updates of the window to the OpenGL scene comprises:
converting the updates of the window to OpenGL textures; and
rendering the OpenGL textures upon a shape in the OpenGL scene.

20. The method of claim 17, wherein rendering the OpenGL scene to a buffer of the first GPU comprises:
rendering the OpenGL scene to an OpenGL frame buffer object.

21. The method of claim 17, wherein copying a second portion of the contents of the buffer of the first GPU to the buffer of the second GPU comprises:
placing the second portion in a pixel buffer object; and
performing a direct memory access transfer of the pixel buffer object.

22. The method of claim 17, further comprising:
selecting a size of the virtual desktop according to a desired size of the composite display.

23. The method of claim 17:
wherein the first display device comprises at least one first projector;
wherein the second display device comprises at least one second projector;
wherein providing the first portion of the contents of the buffer of the first GPU to the first projector comprises warping the first portion; and
wherein providing the contents of the buffer of the second GPU to the second projector comprises warping the contents of the buffer of the second GPU.

24. The method of claim 17, further comprising:
providing a third portion of the contents of the buffer of the first GPU to a third display device; and
providing a portion of the contents of the buffer of the second GPU to a fourth display device;
wherein the first, second, third, and fourth display devices together create the single composite display of the virtual desktop.
